(19) United States
(12) Patent Application Publication
(10) Pub. No.: US 2013/0034253 A1
(43) Pub. Date: Feb. 7, 2013

(54) STEREOPHONIC SOUND APPARATUS FOR VEHICLE

(71) Applicant: Toshiaki NAKAYAMA, Miyoshi-city (JP)

(72) Inventor: Toshiaki NAKAYAMA, Miyoshi-city (JP)

(73) Assignee: DENSO CORPORATION, Kariya-city (JP)

(21) Appl. No.: 13/563,971

(22) Filed: Aug. 1, 2012

(30) Foreign Application Priority Data
Aug. 2, 2011 (JP) 2011-169485

(51) Int. Cl. H04R 5/02

(52) U.S. Cl. 381/302

(57) ABSTRACT

A stereophonic sound apparatus for a vehicle includes ultrasonic speakers and a dual channel reproduction unit. The dual channel reproduction unit modulates a sound signal into an ultrasonic modulated sound having ultrasonic wave frequency, and provides the ultrasonic modulated sound toward a passenger through the reproduction ultrasonic speakers for generating a three-dimensional sound. The dual channel reproduction unit is configured to generate a sub localization sound through the reproduction ultrasonic speakers when generating a front localization sound, the front localization sound being a sound perceived to be generated from a position in front of a seat, and the sub localization sound being a sound perceived to be generated from a position different from the position in front of the seat.

### CROSS REFERENCE TO RELATED APPLICATION

This application is based on Japanese Patent Application No. 2011-169485 filed on Aug. 2, 2011, the disclosure of which is incorporated herein by reference.

### TECHNICAL FIELD

The present disclosure relates to a stereophonic (three-dimensional) sound apparatus for a vehicle, more particularly, relates to a stereophonic sound apparatus that provides three-dimensional localization of sound to a passenger of a vehicle using dual channel speakers.

### BACKGROUND

As an example of a stereophonic sound apparatus for a vehicle, which provides three-dimensional localization of sound (i.e., sound image localization) in direction, such as: ahead or behind; ahead, behind, left, or right; or left, right, ahead, behind, above or below, “binaural recording and headphone playback” technology has been known in JP05-153687A.

The binaural recording is performed using left and right recording microphones mounted in left and right artificial ears of a dummy head. The binaural effect, that is, three-dimensional localization is enabled by directly reproducing a recording (i.e., recorded element) made in the binaural recording in human ears through a headphone (e.g., a speaker applying sound directly to the human ears, such as an ear speaker).

In the “binaural recording and headphone playback”, when the position from which the sound reproduces during the playback, such as the position of the human ears, accords with the position of recording microphones during the recording, such as the position of artificial ears, three-dimensional sound information (information regarding three-dimensional localization of sound) can be properly reproduced.

However, if the position of the human ears is separated from the position of speakers, crosstalk where a sound reproduced from a speaker at one side reaches the ear at an opposite side occurs. In such a case, it is difficult to properly reproduce the three-dimensional sound information to the human ears. Therefore, it is difficult to realize the three-dimensional sound localization.

### SUMMARY

It is an object of the present disclosure to provide a stereophonic sound apparatus for a vehicle, which enables a passenger to orient a sound image in any direction in a passenger's view range even in a situation of obtaining visual information.

According to an aspect of the present disclosure, a stereophonic sound apparatus includes reproduction ultrasonic speakers and a dual channel reproduction unit. The dual channel reproduction unit modulates a sound signal into an ultrasonic modulated sound having ultrasonic wave frequency, and provides the ultrasonic modulated sound toward a passenger through the reproduction ultrasonic speakers for generating a three-dimensional sound. The dual channel reproduction unit is configured to generate a sub localization sound through the reproduction ultrasonic speakers when generating a front localization sound, the front localization sound being a sound perceived to be generated from a position in front of a seat, and the sub localization sound being a sound perceived to be generated from a position different from the position in front of the seat.

In the above stereophonic sound apparatus, the sound signal is modulated into the ultrasonic modulated sound, and the ultrasonic modulated sound is outputted from the reproduction ultrasonic speakers toward the passenger. Therefore, even if the positions of the passenger's ears are separated from the reproduction ultrasonic speakers, the crosstalk is less likely to occur. As such, the front localization sound and the sub localization sound are properly localized. Namely, the passenger can perceive the front localization sound and the sub localization sound to be generated from the respective positions.

Further, the sub localization sound is generated when the front localization sound is generated. The sub localization sound is the sound perceived to be generated from the position different from the position in front of the seat, that is, the position outside of the passenger's view range. Therefore, the sub localization sound can be localized without being affected by visual information. Because the passenger automatically compares the sub localization sound that can be clearly localized and the front localization sound that is localized in the passenger's view range to each other, the front localization sound can be properly localized to any direction in the view range. Accordingly, even when the passenger is in a situation of obtaining the visual information, the front localization sound can be properly localized to the position in front of the seat in the view range.

### BRIEF DESCRIPTION OF THE DRAWINGS

The above and other objects, features and advantages of the present disclosure will become more apparent from the following detailed description made with reference to the accompanying drawings, in which like parts are designated by like reference numbers and in which:

FIG. 1 is a schematic diagram of a stereophonic sound apparatus according to an embodiment of the present disclosure;

FIG. 2 is a schematic diagram of a recording apparatus used in a binaural recording according to the embodiment;

FIGS. 3A and 3B are schematic diagrams for illustrating arrangements of right and left reproduction ultrasonic speakers of the stereophonic sound apparatus according to the embodiment;

FIG. 4 is a diagram illustrating frequency characteristics of a recording made using a dummy head according to the embodiment; and

FIG. 5 is a diagram illustrating frequency characteristics depending on the arrangements of the right and left reproduction ultrasonic speakers according to the embodiment.

### DETAILED DESCRIPTION

Hereinafter, an embodiment of the present disclosure will be described with reference to the drawings.

A stereophonic sound apparatus for a vehicle according to the present embodiment includes a reproduction sound source 1 and a dual channel reproduction unit 2. The reproduction sound source 1 stores a sound signal (e.g., a recording made by a binaural recording) for providing a three-dimensional sound to a passenger of a vehicle. The dual channel reproduction unit 2 reproduces the sound signal stored in the reproduction sound source 1.

The dual channel reproduction unit 2 ultrasonic-modulates the sound signal outputted from the reproduction sound source 1 to provide an ultrasonic modulated sound. The dual channel reproduction unit 2 applies the ultrasonic modulated sound to passenger's ears through left and right reproduction ultrasonic speakers 3, which are spaced from a passenger's head α.

The reproduction sound source 1 stores (a) multiple sound signals for generating “main localization sounds M” that should be perceived by the passenger to be generated from any direction (e.g., ahead, behind, left or right), and (b) a sound signal for generating a “sub localization sound S” that can accentuate the directions of the “main localization sounds M”. The main localization sounds M include “front localization sound” that should be perceived by the passenger to be generated from a front position.

In the stereophonic sound apparatus, at least when the front localization sound, which is one of the multiple main localization sounds M and is perceived to be generated from a position in front of the passenger's seat, is reproduced by the dual channel reproduction unit 2, the sub localization sound S is reproduced in predetermined fashion. For example, the sub localization sound S is reproduced simultaneously with the front localization sound, or alternately to the front localization sound. As another example, the sub localization sound S is reproduced at a predetermined interval from or to the front localization sound. In this case, the sub localization sound S is reproduced so that the sub localization sound S is perceived to be generated from a position different from the position in front of the passenger's seat, that is, a position outside of the passenger's view range, such as from a position behind or a position above.

Next, an example of the stereophonic sound apparatus used for a vehicle will be described in detail. In the following example, the stereophonic sound apparatus is adapted to a sound apparatus for a vehicle, such as a speech sound apparatus for a vehicle. However, the present disclosure is not limited to the sound apparatus, such as the speech sound apparatus. Hereinafter, components similar to the components described hereinabove are designated with like reference numbers.

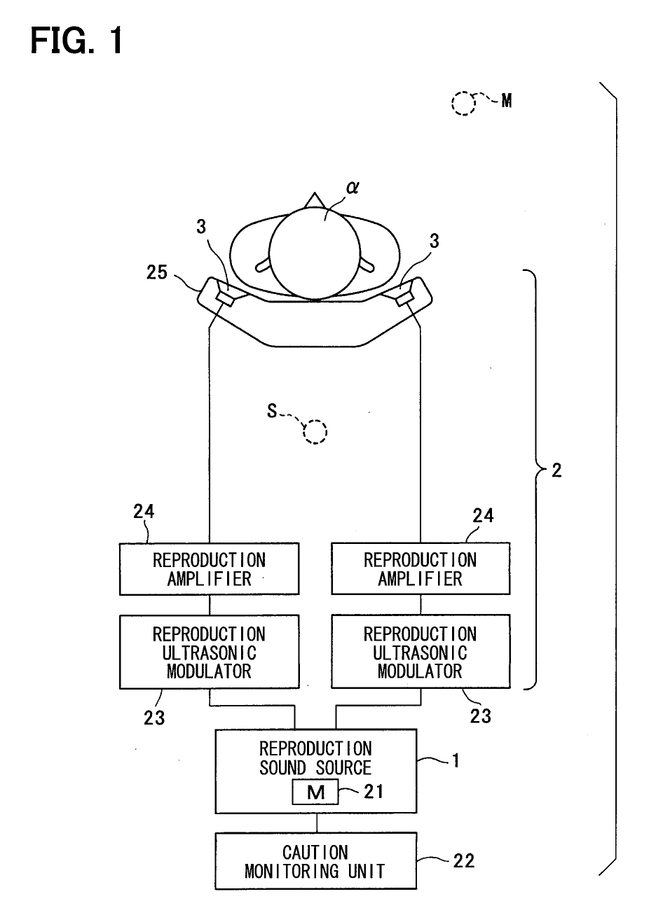

The sound apparatus serves as a warning apparatus that provides “information regarding a direction”, such as information regarding a direction of attention or caution, to a driver by a speech sound. As shown in FIG. 1, the sound apparatus includes: a reproduction sound source 1 that stores a recording made by a binaural recording; and a dual channel reproduction unit 2 that reproduces the recording stored in the reproduction sound source 1. Here, the recording stored in the reproduction sound source 1 corresponds to a sound signal that provides a three-dimensional sound to the driver. The driver is only an example of a target person or passenger to be provided with the three-dimensional sound.

<Explanation of the Recording Stored in the Reproduction Sound Source 1>

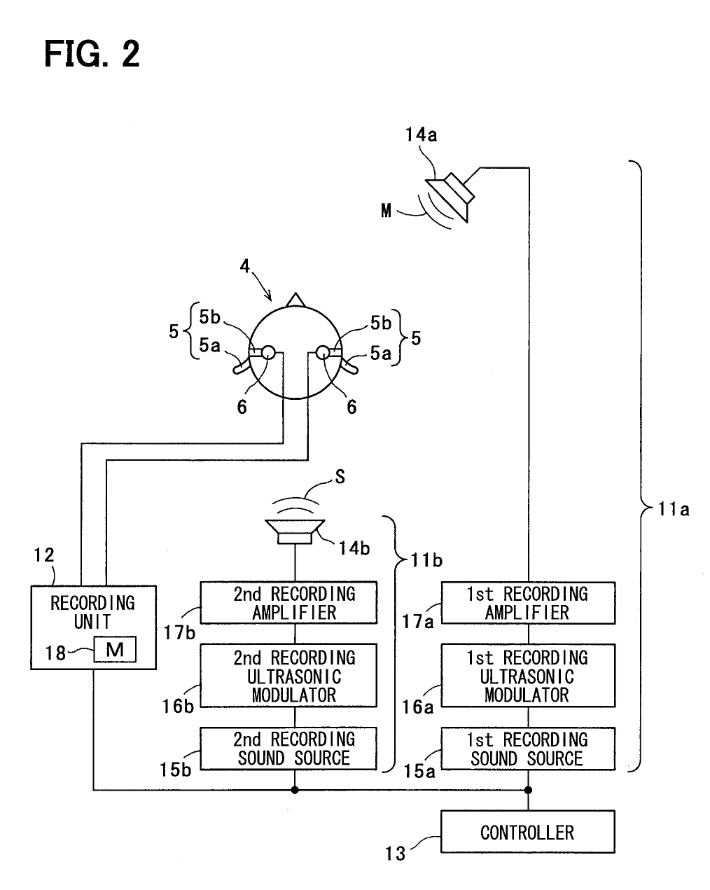

The recording stored in the reproduction sound source 1 is produced by a binaural recording using a dummy head. In the binaural recording, ultrasonic modulation sounds are applied to the dummy head, and sounds captured in the dummy head are recorded. One of the ultrasonic modulation sounds corresponds to a main localization sound M and the other of the ultrasonic sounds corresponds to a sub localization sound S. Each of the ultrasonic modulation sounds is produced by ultrasonic-modulating an audible sound. An example of the binaural recording will be hereinafter described with reference to FIG. 2.

The binaural recording is performed using a dummy head 4. The dummy head 4 imitates a human's head. Left and right recording microphones 6 are mounted in left and right artificial ears 5 of the dummy head 4.

Each of the artificial ears 5 imitates a human's outer ear, and has an artificial ear auricle 5a, such as an earlobe protruding from the head, and an artificial external ear canal 5b, such as an ear hole. The recording microphone 6 is mounted inside of the artificial external ear canal 5b, such as in the back of the artificial external ear canal 5b.

The binaural recording uses first and second sound wave generators 11a, 11b that generate the main localization sound M and the sub localization sound S, as recording sounds, toward the dummy head 4, and a recording unit 12 that records the main localization sound M and the sub localization sound, as recorded sounds, that are captured by the microphones 6. The first and second sound wave generators 11a, 11b and the recording unit 12 are controlled by a controller 13.

<Explanation of the First and Second Sound Wave Generators 11a, 11b>

Each of the first and second sound wave generators 11a, 11b is configured to provide an ultrasonic-modulated sound wave, as the recording sound, to the dummy head 4 through a parametric speaker.

The first sound wave generator 11a has: a first recording ultrasonic speaker 14a for outputting ultrasound in the parametric speaker; a first recording sound source 15a capable of outputting a recording sound signal as an electric signal for generating a fundamental tone of the main localization sound M; a first recording ultrasonic modulator 16a for modulating the recording sound signal outputted from the first recording sound source 15a into ultrasonic frequency; and a first recording amplifier 17a for driving the first recording ultrasonic speaker 14a.

The second sound wave generator 11b has: a second ultrasonic speaker 14b for outputting ultrasound in the parametric speaker; a second recording sound source 15b capable of outputting a recording sound signal as an electric signal for generating a fundamental tone of the sub localization sound S; a second recording ultrasonic modulator 16b for modulating the recording sound signal outputted from the second recording sound source 15b into ultrasonic frequency; and a second recording amplifier 17b for driving the second recording ultrasonic speaker 14b.

The first recording sound source 15a is configured to output multiple main localization signals, as the recording sound signals, corresponding to the fundamental tones of the main localization sounds M based on a command signal provided from the controller 13. The second recording sound source 15b is configured to output a BGM signal (sub localization signal), as the recording sound signal, corresponding to the fundamental tone of the sub localization sound S based on a command signal provided from the controller 13.

For example, the first recording sound source 15a is a sound source that is capable of generating the multiple main localization signals. For easy understanding, the following speech sound announcement signals (information regarding directions) are outputted from the first recording sound source 15a as an example of the multiple main localization signals:

“Please check ahead”;

“Please check to the front right”;

“Please check to the right”;

“Please check to the rear right”;

“Please check behind”;

“Please check to the rear left”;

“Please check to the left”; and

“Please check to the front left”.

The second recording sound source 15b is a sound source of the sub localization sound S relative to the main localization sounds M. As an example of the sub localization sound S outputted from the second recording sound source 15b, for easy understanding, a background music (BGM) signal is outputted.

The BGM is only an example of the sub localization sound S. The sub localization sound S is not limited to the BGM, but may be any other sound, such as an indication sound as an alarm sound that should be generated immediately before the main localization sound M is generated.

The first and second recording ultrasonic modulators 16a, 16b ultrasonic-modulate the main localization signals and the sub localization signal outputted from the first and the second recording sound sources 15a, 15b. Namely, the first and second recording ultrasonic modulators 16a, 16b modulate the main localization signals and the sub localization signal into ultrasonic signals having ultrasonic frequencies.

For example, each of the first and second recording ultrasonic modulators 16a, 16b performs amplitude modulation (AM modulation), that is, modulates the signal outputted from the corresponding one of the first and second recording sound sources 15a, 15b to have am amplitude change (voltage change) in a predetermined ultrasonic frequency (e.g., 25 kHz). The ultrasonic modulation is not limited to the AM modulation, but may be any other ultrasonic modulation, such as a pulse-width modulation (PWM modulation).

The first recording amplifier 17a drives the first recording ultrasonic speaker 14a based on the ultrasonic signal modulated in the first recording ultrasonic modulator 16a. The second recording amplifier 17b drives the second recording ultrasonic speaker 14b based on the ultrasonic signal modulated in the second recording ultrasonic modulator 16b. Namely, the first and second recording ultrasonic speakers 14a, 14b are independently driven. The first and second recording amplifiers 17a, 17b are, for example, a push-pull class B amplifier or a push-pull class D amplifier.

The first recording ultrasonic speaker 14a generates an ultrasonic wave that is produced by modulating the main localization signal toward the dummy head 4. The second recording ultrasonic speaker 14b generates an ultrasonic wave that is produced by modulating the BGM signal (sub localization signal) toward the dummy head 4.

In this case, a sound pressure of the sub localization sound S applied to the driver's ears is lower than a sound pressure of the main localization sounds M (e.g., front localization sound) applied to the driver's ears by 10 dB to 20 dB, for example.

As a specific example of differentiating the sound pressures of the sub localization sound S and the main localization sounds M, a driving gain of the second recording amplifier 17b is set lower than a driving gain of the first recording amplifier 17a in the binaural recording. In the present embodiment, for example, the driving gain of the second recording amplifier 17b is set to a predetermined level so that the sound pressure applied from the second recording ultrasonic speaker 14b to the dummy head 4 is lower than the sound pressure applied from the first recording ultrasonic speaker 14a to the dummy head 4 by 10 dB or more.

Each of the first and second recording ultrasonic speakers 14a, 14b generates air vibration having a frequency (e.g., 20 kHz or more) higher than a human's audible frequency range. For example, each of the first and second recording ultrasonic speakers 14a, 14b is constructed of multiple ultrasonic generating elements that generate ultrasonic waves.

The multiple ultrasonic generating elements are collectively arranged on a support plate or the like, and are provided as a speaker array. An example of the ultrasonic generating element is a piezoelectric speaker, which is suitable to generate an ultrasonic wave. The piezoelectric speaker includes a piezoelectric element that is expanded or contracted in accordance with an applied voltage (charging and discharging) and a vibrating plate that generates compressional wave in air by being driven by expansion and contraction of the piezoelectric element.

The ultrasonic wave radiated from the first recording ultrasonic speaker 14a toward the dummy head 4 becomes dull as an ultrasonic wave with a short wave length is distorted due to viscosity of the air while propagating through the air. An amplitude component contained in the ultrasonic wave is self-demodulated in the air during the propagation. Thus, the ultrasonic wave radiated from the first recording ultrasonic speaker 14a is reproduced as the main localization sound M in the dummy head 4.

Likewise, the ultrasonic wave radiated from the second recording ultrasonic speaker 14b toward the dummy head 4 becomes dull as an ultrasonic wave with a short wave length is distorted due to viscosity of the air while propagating through the air. An amplitude component contained in the ultrasonic wave is self-demodulated in the air during the propagation. Thus, the ultrasonic wave radiated from the second recording ultrasonic speaker 14b is reproduced as the BGM in the dummy head 4.

<Explanation of the Recording Unit 12>

The recording unit 12 is a digital recording device (e.g., personal computer) that stores (records) the dual channel sound wave signal captured by each of the left and right recording microphones 6 in an independent (separate) address in a memory 18, as the recording.

<Explanation of a Recording Method>

The position of the first recording ultrasonic speaker 14a relative to the dummy head 4, that is, the direction of the first recording ultrasonic speaker 14a to the dummy head 4 is changed in every recording. Further, the first recording ultrasonic speaker 14a is placed so that the ultrasonic wave is radiated toward a substantially center of the dummy head 4 in every recording.

The second recording ultrasonic speaker 14b is fixed. That is, the second recording ultrasonic speaker 14b is always positioned behind the dummy head 4. The second recording ultrasonic speaker 14b is placed so that the ultrasonic wave is radiated toward a substantially center of the back of the dummy head 4.

The recording is preferably performed in a place of having fewer echoes, such as in a sound-proof room, but may be performed in any other place.

(a) In the recording of “please check ahead” as an example of the main localization sounds M, the first recording ultrasonic speaker 14a is placed in front of the dummy head 4 and is faced toward the face of the dummy head 4. Also, the second recording ultrasonic speaker 14b is placed just behind the dummy head 4 and is faced toward the back of the dummy head 4. In this state, sounds captured in the recording microphones 6 are recorded and the recordings are stored in the memory 18.

Thus, in the memory 18, dual channel first sound signals including the sound “please check ahead” that can be heard from the front position of the dummy head 4 and the BGM sound that can be simultaneously heard from the just rear position of the dummy head 4 are stored in the memory 18 as the recordings.

(b) In the recording of “please check to the front right” as an example of the main localization sounds M, the first recording ultrasonic speaker 14a is placed to a right front position of the dummy head 4 and is faced toward the dummy head 4. Also, the second recording ultrasonic speaker 14b is placed just behind the dummy head 4 and is faced toward the back of the dummy head 4. In this state, sounds captured in the recording microphones 6 are recorded and the recordings are stored in the memory 18.

Thus, in the memory 18, dual channel second sound signals including the sound “please check the front right” that can be heard from the front right position of the dummy head 4 and the BGM sound that can be simultaneously heard from the just rear position of the dummy head 4 are stored in the memory 18 as the recordings.

(c) In the recording of “please check to the right” as an example of the main localization sounds M, the first recording ultrasonic speaker 14a is placed to a right position of the dummy head 4 and is faced toward the dummy head 4. Also, the second recording ultrasonic speaker 14b is placed just behind the dummy head 4 and is faced toward the back of the dummy head 4. In this state, sounds captured in the recording microphones 6 are recorded and the recordings are stored in the memory 18.

Thus, in the memory 18, dual channel third sound signals including the sound “please check to the right” that can be heard from the right position of the dummy head 4 and the BGM sound that can be simultaneously heard from the just rear position of the dummy head 4 are stored in the memory 18 as the recordings.

(d) In the recording of “please check to the rear right” as an example of the main localization sounds M, the first recording ultrasonic speaker 14a is placed to a rear right position of the dummy head 4 and is faced toward the dummy head 4. Also, the second recording ultrasonic speaker 14b is placed just behind the dummy head 4 and is faced toward the back of the dummy head 4. In this state, sounds captured in the recording microphones 6 are recorded and the recordings are stored in the memory 18.

Thus, in the memory 18, dual channel fourth sound signals including the sound “please check to the rear right” that can be heard from the rear right position of the dummy head 4 and the BGM sound that can be simultaneously heard from the just rear position of the dummy head 4 are stored in the memory 18 as the recordings.

(e) In the recording of “please check behind” as an example of the main localization sounds M, the first recording ultrasonic speaker 14a is placed just behind of the dummy head 4 and is faced toward the dummy head 4. Also, the second recording ultrasonic speaker 14b is placed just behind the dummy head 4 and is faced toward the back of the dummy head 4. In this state, sounds captured in the recording microphones 6 are recorded and the recordings are stored in the memory 18.

Thus, in the memory 18, dual channel fifth sound signals including the sound “please check behind” that can be heard from the just rear position of the dummy head 4 and the BGM sound that can be simultaneously heard from the just rear position of the dummy head 4 are stored in the memory 18 as the recordings.

(f) In the recording of “please check to the rear left” as an example of the main localization sounds M, the first recording ultrasonic speaker 14a is placed to a rear left position of the dummy head 4 and is faced toward the dummy head 4. Also, the second recording ultrasonic speaker 14b is placed just behind the dummy head 4 and is faced toward the back of the dummy head 4. In this state, sounds captured in the recording microphones 6 are recorded and the recordings are stored in the memory 18.

Thus, in the memory 18, dual channel sixth sound signals including the sound “please check the front right” that can be heard from the rear left position of the dummy head 4 and the BGM sound that can be heard from the just rear position of the dummy head 4 are stored in the memory 18 as the recordings.

(g) In the recording of “please check to the left” as an example of the main localization sounds M, the first recording ultrasonic speaker 14a is placed to a left position of the dummy head 4 and is faced toward the dummy head 4. Also, the second recording ultrasonic speaker 14b is placed just behind the dummy head 4 and is faced toward the back of the dummy head 4. In this state, sounds captured in the recording microphones 6 are recorded and recordings are stored in the memory 18.

Thus, in the memory 18, dual channel seventh sound signals including the sound “please check to the left” that can be heard from the left position of the dummy head 4 and the BGM sound that can be simultaneously heard from the just rear position of the dummy head 4 is stored in the memory 18 as the recordings.

(h) In the recording of “please check to the front left” as an example of the main localization sounds M, the first recording ultrasonic speaker 14a is placed to a front left position of the dummy head 4 and is faced toward the dummy head 4. Also, the second recording ultrasonic speaker 14b is placed just behind the dummy head 4 and is faced toward the back of the dummy head 4. In this state, sounds captured in the recording microphones 6 are recorded and recordings are stored in the memory 18.

Thus, in the memory 18, dual channel eighth sound signals including the sound “please check the front left” that can be heard from the front left position of the dummy head 4 and the BGM sound that can be simultaneously heard from the just rear position of the dummy head 4 are stored in the memory 18 as the recordings.

<Explanation of the Speech Sound Apparatus>

The speech sound apparatus of the example has: (i) a reproduction sound source 1 that includes a memory 21 to which the above described first through eighth sound signals (recordings) stored in the memory 18 are copied; (ii) a dual channel reproduction unit 2 that reproduces the first through eighth sound signals outputted from the reproduction sound source 1; and (iii) a caution monitoring unit 22 for instructing the reproduction sound source 1 to output a specific one of the first through eighth sound signals.

The caution monitoring unit 22 has: a monitoring device, such as an image analysis device using an ultrasonic sonar, a CCD camera and the like, for monitoring a condition of a peripheral area of the vehicle; a caution direction determining section that determines which direction (area) of the vehicle a matter to be attended has occurred based on a monitoring result of the monitoring device; and a reproduction signal instructing section that instructs the reproduction sound source 1 to output the specific sound signal based on a determination result of the caution direction determination section.

The above caution monitoring unit 22 is only an example for understanding, and may be provided by any other unit.

Specifically, the reproduction signal instructing section instructs the reproduction sound source 1 as follows:

(a) when the caution direction determining section determines that the matter to be attended has occurred in a front area, the reproduction signal instructing section instructs the reproduction sound source 1 to output the first sound signal;

(b) when the caution direction determining section determines that the matter to be attended has occurred in a front right area, the reproduction signal instructing section instructs the reproduction sound source 1 to output the second sound signal;

(c) when the caution direction determining section determines that the matter to be attended has occurred in a right area, the reproduction signal instructing section instructs the reproduction sound source 1 to output the third sound signal;

(d) when the caution direction determining section determines that the matter to be attended has occurred in a rear right area, the reproduction signal instructing section instructs the reproduction sound source 1 to output the fourth sound signal;

(e) when the caution direction determining section determines that the matter to be attended has occurred in a rear area, the reproduction signal instructing section instructs the reproduction sound source 1 to output the fifth sound signal;

(f) when the caution direction determining section determines that the matter to be attended has occurred in a rear left area, the reproduction signal instructing section instructs the reproduction sound source 1 to output the sixth sound signal;

(g) when the caution direction determining section determines that the matter to be attended has occurred in a left area, the reproduction signal instructing section instructs the reproduction sound source 1 to output the seventh sound signal; and

(h) when the caution direction determining section determines that the matter to be attended has occurred in a front left area, the reproduction signal instructing section instructs the reproduction sound source 1 to output the eighth sound signal;

<Explanation of the Dual Channel Reproduction Unit 2>

The dual channel reproduction unit 2 provides “the information regarding the direction” to the driver using dual channel parametric speakers. The dual channel reproduction unit 2 has: left and right reproduction ultrasonic speakers 3 for generating ultrasonic waves to the left and right ears of the driver; dual channel reproduction ultrasonic modulators 23 that modulate frequency of the dual channel sound signals as the recordings outputted from the reproduction sound source 1 into ultrasonic wave frequency; and dual channel reproduction amplifiers 24 that drive the right and left reproduction ultrasonic speakers 3.

Each of the reproduction ultrasonic speakers 3 generates air vibration at frequency higher than a human's audible frequency range (e.g., 20 kHz or more). The reproduction ultrasonic speakers 3 may have the same basic structure as that of the first and second recording ultrasonic speakers 14a, 14b or may be any other type of the ultrasonic speakers (e.g., ribbon speaker).

The left and right reproduction ultrasonic speakers 3 radiate ultrasonic wave toward the left and right ears of the driver from positions separated from a driver's head α. In an example shown in FIG. 1, the left and right reproduction ultrasonic speakers 3 are arranged in a vehicle seat 25, such as a headrest or a top portion of a backrest.

The arrangement position of the left and right reproduction ultrasonic speakers 3 is not limited to the vehicle seat 25, but may be any other position, such as at sides of a meter panel (e.g., dashboard), left and right pillars at left and right ends of a front windshield, a ceiling of the vehicle or the like.

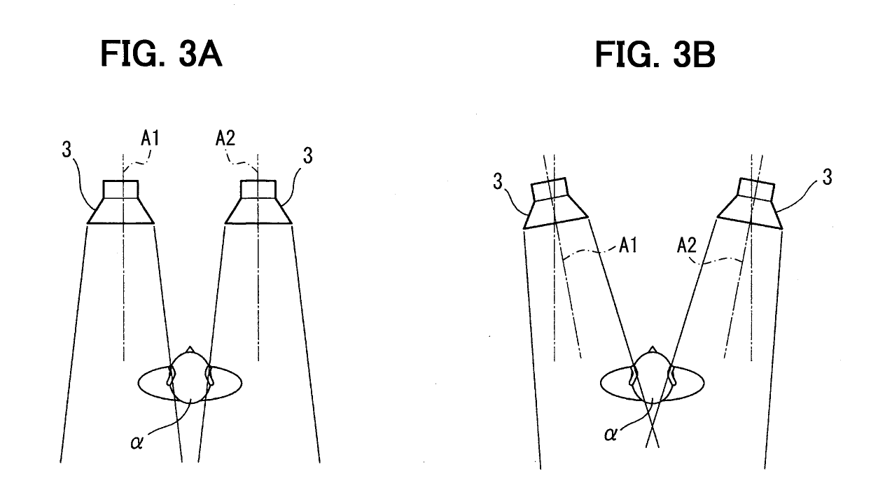

FIG. 3A is a diagram illustrating an example of arrangement of the left and right reproduction ultrasonic speakers 3 in which radiation axes A1, A2 of the ultrasonic waves from the reproduction ultrasonic speakers 3 are parallel to each other. FIG. 3B is a diagram illustrating an example of arrangement of the left and right reproduction ultrasonic speakers 3 in which radiation axes A1, A2 of the ultrasonic waves from the reproduction ultrasonic speakers 3 are inclined inwardly. In the present embodiment, the reproduction ultrasonic speakers 3 are arranged in the manner of FIG. 3B. Specifically, in the example of FIG. 3B, the radiation axes A1, A2 of the ultrasonic waves of the reproduction ultrasonic speakers 3 intersect with each other in a direction to the driver. In this case, the radiation axes A1, A2 may intersect at any position, such as ahead of the driver, at the driver's head α, or behind the driver.

The reproduction ultrasonic modulators 23 modulate the frequency of the dual channel sound signals outputted from the reproduction sound source 1 as the recordings into ultrasonic wave frequency. For example, each of the reproduction ultrasonic modulators 23 performs amplitude modulation (AM modulation), that is, modulates the signal outputted from the reproduction sound source 1 to have am amplitude change (voltage change) in a predetermined ultrasonic wave frequency (e.g., 25 kHz). The ultrasonic modulation is not limited to the AM modulation, but may be any other ultrasonic modulation, such as a pulse-width modulation (PWM modulation).

The dual channel reproduction amplifiers 24 drive the left and right reproduction ultrasonic speakers 3 independently based on the ultrasonic signal modulated in the reproduction ultrasonic modulators 23. The dual channel reproduction amplifiers 24 are, for example, a push-pull class B amplifier or a push-pull class D amplifier. The dual channel reproduction amplifier 24 drive the left and right reproduction ultrasonic speakers 3 to output the ultrasonic waves that are produced by modulating the sound signal as the recordings toward the left and right ears of the driver.

The modulated ultrasonic waves of the sound signals, which are radiated from the left and right reproduction ultrasonic speakers 3 toward the left and right ears of the driver, become dull as an ultrasonic wave with a short wave length is distorted due to viscosity of the air while propagating through the air. In this case, an amplitude component contained in the ultrasonic wave is self-demodulated in the air during the propagation. Thus, the speech sound announcement and the BGM are reproduced in the right and left ears of the driver, as the main localization sound M and the sub localization sound S.

Alternatively, the ultrasonic wave that reaches the driver's head α before the self-modulation is self-modulated in the driver's head α (e.g., near the ears). Also in this case, the speech sound announcement and the BGM are reproduced in the right and left ears of the driver, as the main localization sound M and the sub localization sound S.

Next, an operation of the speech sound apparatus will be hereinafter described in detail.

(a) In a case where the caution direction determining section of the caution monitoring unit 22 determines that the matter to be attended has occurred in the front area, the reproduction sound source 1 outputs the first sound signal as the recording. As such, the driver perceives the BGM to be generated just behind and the main localization sound M of “please check ahead” to be generated from the just front position.

(b) In a case where the caution direction determining section determines that the matter to be attended has occurred in the front right area, the reproduction sound source 1 outputs the second sound signal as the recording. As such, the driver perceives the BGM to be generated just behind and the main localization sound M of “please check to the front right” to be generated from the front right position.

(c) In a case where the caution direction determining section determines that the matter to be attended has occurred in the right area, the reproduction sound source 1 outputs the third sound signal as the recording. As such, the driver perceives the BGM to be generated just behind and the main localization sound M of “please check to the right” to be generated from the right position.

(d) In a case where the caution direction determining section determines that the matter to be attended has occurred in the rear right area, the reproduction sound source 1 outputs the fourth sound signal as the recording. As such, the driver perceives the BGM to be generated just behind and the main localization sound M of “please check to the rear right” to be generated from the rear right position.

(e) In a case where the caution direction determining section determines that the matter to be attended has occurred in the rear area, the reproduction sound source 1 outputs the fifth sound signal as the recording. As such, the driver perceives the BGM to be generated just behind and the main localization sound M of “please check behind” to be generated from the just rear position.

(f) In a case where the caution direction determining section determines that the matter to be attended has occurred in the rear left area, the reproduction sound source 1 outputs the sixth sound signal. As such, the driver perceives the BGM to be generated just behind and the main localization sound M of “please check to the rear left” to be generated from the rear left position.

(g) In a case where the caution direction determining section determines that the matter to be attended has occurred in the left area, the reproduction sound source 1 outputs the seventh sound signal as the recording. As such, the driver hears the BGM to be generated just behind and the main localization sound M of “please check to the rear left” to be generated from the left position.

(h) In a case where the caution direction determining section determines that the matter to be attended has occurred in the front left area, the reproduction sound source 1 outputs the eighth sound signal as the recording. As such, the driver perceives the BGM to be generated just behind and the main localization sound M of “please check to the front left” to be generated from the front left position.

In the above described example of the present embodiment, the following advantageous effects are achieved:

(1) Since the first through eighth sound signals as the recordings are applied to the driver's left and right ears after being modulated into the ultrasonic wave frequency, crosstalk is less likely to occur. Therefore, the main localization sounds M (e.g., the speech sound announcements) are clearly localized to the respective directions to the driver, and the sub localization sound S (e.g., the BGM) is clearly localized behind the driver.

In fact, the driver positively obtains visual information during driving of the vehicle. In a case where the present disclosure is not employed, the visual information has priority over auditory information. In such a case, therefore, it is difficult to localize the main localization sounds M, such as the front localization sounds including “please check ahead,” “please check to the front right” and “please check to the front left” to the respective directions within the range of driver's view.

In the speech sound apparatus of the present embodiment, on the other hand, when the front localization sounds to be localized to the front positions, such as “please check ahead”, “please check to the front right”, and “please check to the front left”, are generated, the sub localization sound S that is perceived to be generated from the rear position is also generated.

Since the sub localization sound S is the sound localized behind the driver, which is outside of the driver's view range, the sub localization sound S can be easily and clearly localized to the behind of the driver without being affected by the visual information. Thus, the driver automatically compares the sub localization sound S localized behind and the front localization sound localized in the view range to each other in his/her brain and localizes the front localization sound to the direction in his/her front area.

Accordingly, the speech sound apparatus of the present embodiment enables the driver to properly localize the front localization sounds to the respective directions within his/her view range, even in a driving situation obtaining the visual information.

(2) The sub localization sound S to be localized behind is generated even when the main localization sounds M other than the front localization sounds are generated. That is, the sub localization sound S is generated also when the main localization sounds M to be localized to directions outside of the driver's view range are generated.

Also in this case, the driver automatically compares the main localization sounds M other than the front localization sounds to the sub localization sound S. Therefore, the main localization sounds M other than the front localization sounds can be also properly localized. Namely, the direction to which the sound image of the main localization sound M is localized can be accentuated.

(3) The sound signals stored in the reproduction sound source 1 are the recordings produced by the binaural recording. Namely, the sound signals for localizing sound images to any directions as the main localization sounds M and the sub localization sound S are obtained by the binaural recording. The sound signals can be easily and properly obtained without using a phase control technique, such as crosstalk cancel or the like. As a result, the sound images can be properly localized in any directions to the driver.

(4) The sound signals stored in the reproduction sound source 1 are the recordings produced by applying the ultrasonic modulated sounds to the dummy head 4 and recording sounds captured in the dummy head 4. The ultrasonic modulated sounds are produced by modulating the frequencies of the main localization sound M and the sub localization sound S into ultrasonic wave frequencies.

Because directionality of the ultrasonic wave is strong, the three-dimensional sound information can be clearly applied to the left and right recording microphones 6. As a result, localization properties of the sound directions of the recordings improve, as compared with a general binaural recording in which the sound signals are not modulated into the ultrasonic wave frequency. Therefore, even in a passenger compartment of the vehicle where a sound is easily reflected or blurred, the effect of localizing the sound image to any direction to the driver improves.

(5) The dummy head 4 used for the binaural recording has the artificial ear auricles 5a and the artificial external ear canals 5b, and the left and right microphones 6 are mounted inside of the artificial external ear canals 5b. Therefore, the sound prepared for the recording can be recorded in a condition further similar to a human's actual ear condition.

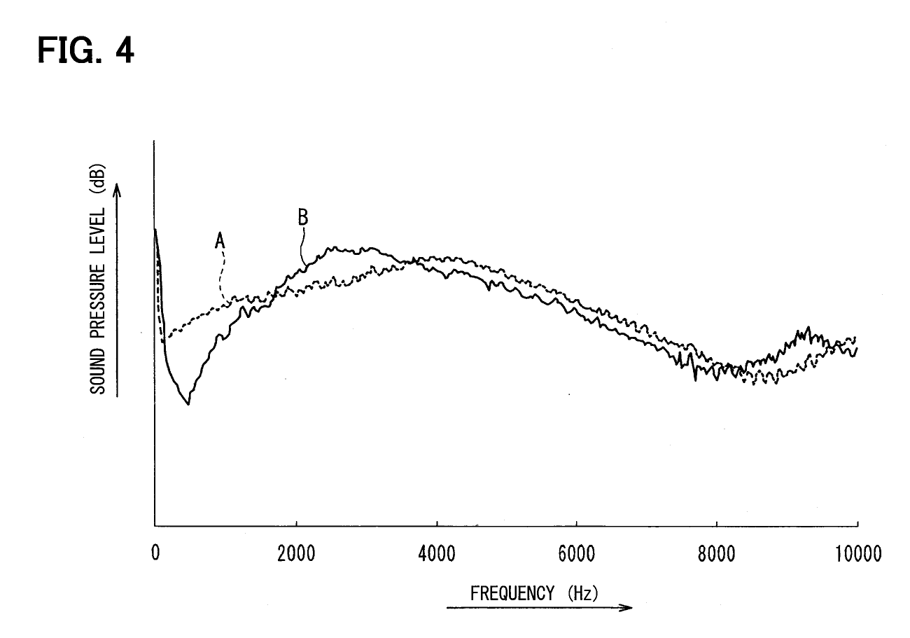

For example, in a general dummy head without having the artificial ear auricles 5a and the artificial external ear canals 5b, the sound captured in such dummy head has frequency characteristics without having the effect of the external ear including the ear auricle and the external ear canal, as shown by a dashed line A in FIG. 4. Therefore, it is difficult to record three-dimensional sound information accurately.

On the other hand, the dummy head 4 of the present embodiment has the artificial ear auricles 5a and the artificial external ear canals 5b. Therefore, the sound captured in the dummy head 4 has frequency characteristics having the effect of the external ear including the ear auricle and the external ear canal, as shown by a solid line B in FIG. 4. Accordingly, it is possible to record three-dimensional information accurately.

Since the dummy head 4 has the artificial ear auricles 5a and the artificial external ear canals 5b, the accuracy of three-dimensional information in the binaural recording improves. As a result, the accuracy of three-dimensional sound localization provided to the driver improves.

(6) The sound pressure of the sub localization sound S applied to the driver's left and right ears from the left and right reproduction ultrasonic speakers 3 is smaller than the sound pressure of the main localization sounds M including the front localization sounds by 10 dB or more. Therefore, the main localization sounds M including the front localization sounds can be accentuated more than the sub localization sound S.

(7) The right and left reproduction ultrasonic speakers 3 are arranged inwardly so that the radiation axes are inclined toward the driver. Therefore, the ultrasonic modulated sounds radiated from the right and left reproduction ultrasonic speakers 3 reach the tympanic membranes of the driver while reducing the influence of the driver's external ear canals. Therefore, the accuracy of three-dimensional sound information applied to the tympanic membranes improves.

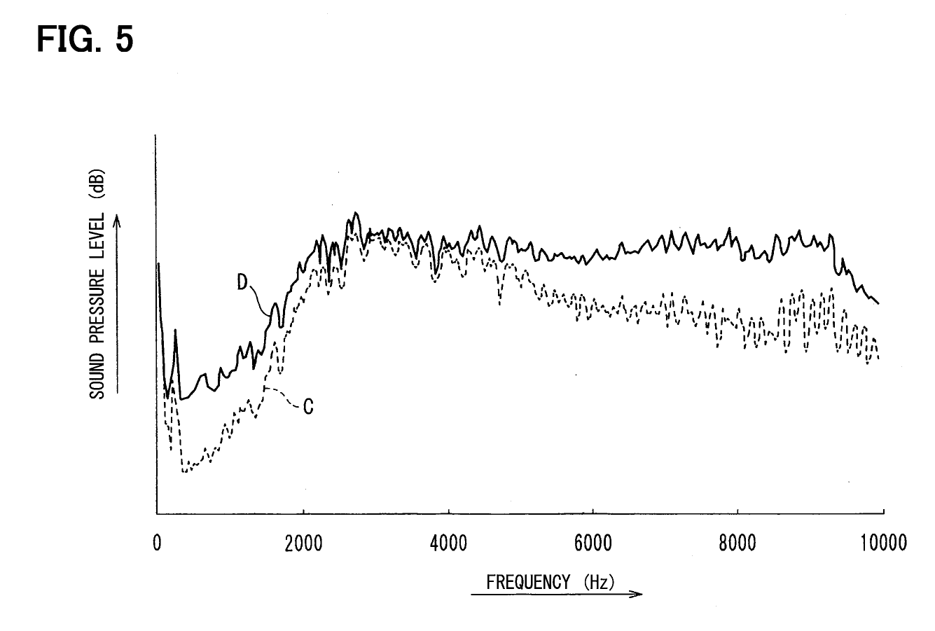

For example, in the case where the left and right reproduction ultrasonic speakers 3 are arranged so that the radiation axes are parallel to each other, the traveling direction of the ultrasonic wave and the axis of the external ear canal are orthogonal to each other. Therefore, ultrasonic wave in a low frequency band, such as 2 kHz or less, does not reach the tympanic membranes. In such a case, it is difficult for the driver to accurately obtain the three-dimensional sound information, as shown by a dashed line C in FIG. 5.

In the present embodiment, on the other hand, the right and left reproduction ultrasonic speakers 3 are arranged such that the radiation axes are inclined inwardly. Therefore, a part of the ultrasonic wave enters the inside of the external ear canal. With this, the ultrasonic wave in the low frequency band, such as 2 kHz or less, can easily reach the tympanic membranes. Accordingly, the driver can obtain the three-dimensional sound information accurately.

In such a case, even if the right and left reproduction ultrasonic speakers 3 are separated from the driver's head α, the right and left reproduction ultrasonic speakers 3 can be used in a similar condition to a headphone. Accordingly, the accuracy of the three-dimensional sound localization improves in the speech sound apparatus without using the headphone.

(8) The speech sound apparatus of the present embodiment improves the three-dimensional sound localization even if the headphone is not used. Therefore, the speech sound apparatus of the present embodiment can be used in vehicles.

In addition, the driver can perceive the information regarding the directions from the respective directions. Namely, the driver can quickly recognize the direction to be attended. Therefore, the time for recognize the caution direction can be shortened. Accordingly, a performance to provide the attention to the driver improves.

In the above described example of the embodiment, the main localization sound M (e.g., speech sound announcement) is recorded simultaneously with the sub localization sound S in the binaural recording, and the main localization sound M is generated simultaneously with the sub localization sound S in the reproduction. As another example, the main localization sound M and the sub localization sound S may be recorded separately, and be generated simultaneously in the reproduction. As further another example, the main localization sound M and the sub localization sound S may be recorded separately, and be generated with a time lag in the reproduction.

The later example will be described in detail for the understanding. For example, as an example of the sub localization sound S, an indication sound such as an alarm sound or a chime sound, which is localized behind or above the driver's seat, is solely recorded. Then, in the reproduction, the main localization sound. M (speech sound announce or the like) may be generated immediately after the indication sound as the sub localization sound S is generated.

In the above described example of the embodiment, the sub localization sound S is generated when each of the main localization sounds M (speech sound announcements) is reproduced. Alternatively, in a case where the direction of localization of the main localization sound M is outside of the driver's view range, or in a case where the sound localization can be properly provided without using the sub localization sound S, only the main localization sound M may be reproduced.

In the above described example of the embodiment, the sub localization sound S is localized to the rear of the seat (e.g., just behind of the passenger). Alternatively, the sub localization sound S may be localized to any other directions, such as above the seat (e.g., above the passenger's head).

As an example, the sub localization sound S can be localized so that the sub localization sound S is perceived to be generated from a direction 180 degrees different from the direction of the main localization sound M.

In the above described example of the embodiment, the dummy head 4 is used in the binaural recording. However, the binaural recording is not limited to the method of using the dummy head 4. For example, the binaural recording may be performed using any other-type of binaural recording apparatus, such as an apparatus using a helmet capped on a person.

In the above described example of the embodiment, the present disclosure is adapted to the caution apparatus for the vehicle. However, the use of the preset disclosure is not limited to the above described example. For example, the present disclosure may be adapted to a navigation system for providing a passenger with the information regarding the directions (e.g., speech sound announcements).

In the above described example, the present disclosure is adopted to the speech sound apparatus for a vehicle for providing the speech sound information with the passenger. However, the use of the present disclosure is not limited to the above described example. The present disclosure may be adopted to a vehicle audio apparatus for providing a passenger with music or the like.

While only the selected exemplary embodiments have been chosen to illustrate the present disclosure, it will be apparent to those skilled in the art from this disclosure that various changes and modifications can be made therein without departing from the scope of the disclosure as defined in the appended claims. Furthermore, the foregoing description of the exemplary embodiments according to the present disclosure is provided for illustration only, and not for the purpose of limiting the disclosure as defined by the appended claims and their equivalents.

What is claimed is:

1. A stereophonic sound apparatus for a vehicle, comprising:
a plurality of reproduction ultrasonic speakers; and
a dual channel reproduction unit that modulates a sound signal into an ultrasonic modulated sound having ultrasonic wave frequency, and provides the ultrasonic modulated sound toward a passenger through the reproduction ultrasonic speakers for generating a three-dimensional sound, wherein
the dual channel reproduction unit is configured to generate a sub localization sound through the reproduction ultrasonic speakers when generating a front localization sound, the front localization sound being a sound perceived to be generated from a position in front of a seat, the sub localization sound being a sound perceived to be generated from a position different from the position in front of the seat.

2. The stereophonic sound apparatus according to claim 1, wherein the sound signal is a recording made by a binaural recording.

3. The stereophonic sound apparatus according to claim 2, wherein the recording is an ultrasonic modulated recording made by recording a sound that is generated by reproducing an ultrasonic modulated sound from a recording ultrasonic speaker, the ultrasonic modulated sound being produced by modulating an audible sound into ultrasonic wave frequency.

4. The stereophonic sound apparatus according to claim 2, wherein
the binaural recording records audible sound using recording microphones disposed in left and right artificial ears,
each of the artificial ears imitates a human ear, and has an artificial ear auricle and an artificial external ear canal, and
each of the recording microphones is disposed in the artificial external ear canal.

5. The stereophonic sound apparatus according to claim 1, wherein the sub localization sound has a sound pressure lower than that of the front localization sound.

6. The stereophonic sound apparatus according to claim 5, wherein the sub localization sound includes a rear localization sound that is perceived to be generated from a position behind the seat.

7. The stereophonic sound apparatus according to claim 1, wherein the ultrasonic speakers are arranged in an inwardly facing manner at left and right sides of the passenger such that radiation axes of the ultrasonic wave from the ultrasonic speakers are inclined to each other toward the passenger.

8. The stereophonic sound apparatus according to claim 1, wherein the front localization sound is a sound that provides information regarding a direction to the passenger.

9. The stereophonic sound apparatus according to claim 1, wherein the reproduction ultrasonic speakers are disposed at positions separated from a head of the passenger, and provides the ultrasonic modulated sound toward ears of the passenger.
